(19) United States
(12) Patent Application Publication
(10) Pub. No.: US 2013/0228405 A1
(43) Pub. Date: Sep. 5, 2013

(54) BRAKE OPERATING DEVICE OF ELECTRIC BICYCLE WITH HALL-EFFECT SENSOR

(71) Applicant: Szu-Fang Tsai, Changhua (TW)

(72) Inventor: Szu-Fang Tsai, Changhua (TW)

(21) Appl. No.: 13/410,244

(22) Filed: Mar. 1, 2012

(51) Int. Cl. B62L 3/02

(52) U.S. Cl. 188/344

(57) ABSTRACT

A brake operating device of an electric bicycle is provided with a brake lever; a housing comprising a pivot portion pivotably secured to the brake lever, a hydraulic cylinder, a piston disposed in the hydraulic cylinder and having one end connected to the brake lever, a spring depressible magnet disposed in the hydraulic cylinder and having one end adhered to the other end of the piston, and a cylindrical socket adjacent to and parallel to the hydraulic cylinder; a spring depressible Hall-effect sensor disposed in the socket and including a Hall IC; a hollow fastener adjustably threadedly secured to an opening of the socket and engaging the Hall-effect sensor; and a control line inserted through the fastener to electrically connect to the Hall IC.

### BACKGROUND OF THE INVENTION

1. Field of the Invention

The invention relates to bicycle brakes and more particularly to a Hall-effect sensor type brake operating device of an electric bicycle.

2. Description of Related Art

A conventional brake operating device of electric bicycle is shown in FIG. 6 and comprises a housing 71, a brake lever 72 rotatably mounted on the housing 71, a cable 73 having one end secured to the brake lever 72, a control line 74 having one end fastened in the housing 71 and the other end electrically connected to a DC motor (not shown), and a contact switch 75 provided at one end of the control line 74.

In an inoperative state of the brake operating device, the brake lever 72 presses against the contact switch 75 to enable the control line 74. In response to pressing the brake lever 72 against a grip (not shown), the contact switch 75 elastically moves away from the control line 74 to open the circuit. As a result, a braking force is transmitted from the cable 73 to the brake near the wheel.

However, a number of drawbacks have been found in the conventional brake operating device of electric bicycle. In detail, the contact switch is poor in sensitivity. Further, the contact switch is neither robust nor durable. Thus, the need for improvement still exists.

### SUMMARY OF THE INVENTION

It is therefore one object of the invention to provide a brake operating device of an electric bicycle comprising a brake lever; a housing comprising a pivot portion pivotably secured to the brake lever, a hydraulic cylinder, a piston disposed in the hydraulic cylinder and having one end connected to the brake lever, a spring depressible magnet disposed in the hydraulic cylinder and having one end adhered to the other end of the piston, and a cylindrical socket adjacent to and parallel to the hydraulic cylinder; a spring depressible Hall-effect sensor disposed in the socket and comprising a Hall IC (integrated circuit); a hollow fastener adjustably threadedly secured to an opening of the socket and engaging the Hall-effect sensor; and a control line inserted through the fastener to electrically connect to the Hall IC.

The above and other objects, features and advantages of the invention will become apparent from the following detailed description taken with the accompanying drawings.

### BRIEF DESCRIPTION OF THE DRAWINGS

FIG. 1 is a perspective view in part section of a brake operating device of electric bicycle according to the invention;

FIG. 2 is a view similar to FIG. 1 with some components disengaged;

FIG. 3 is a perspective view of the Hall-effect sensor and the control line;

FIG. 4 is a side elevation of FIG. 3;

FIG. 5 is an enlarged view in part section of the Hall-effect sensor; and

FIG. 6 is a schematic sectional view of a conventional brake operating device of electric bicycle.

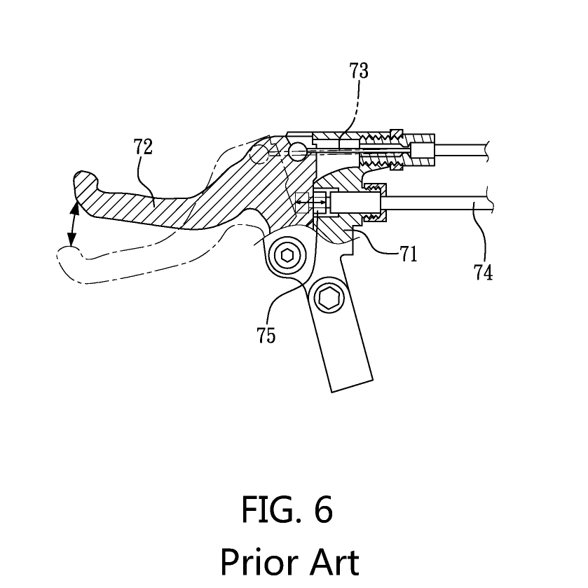

### DETAILED DESCRIPTION OF THE INVENTION

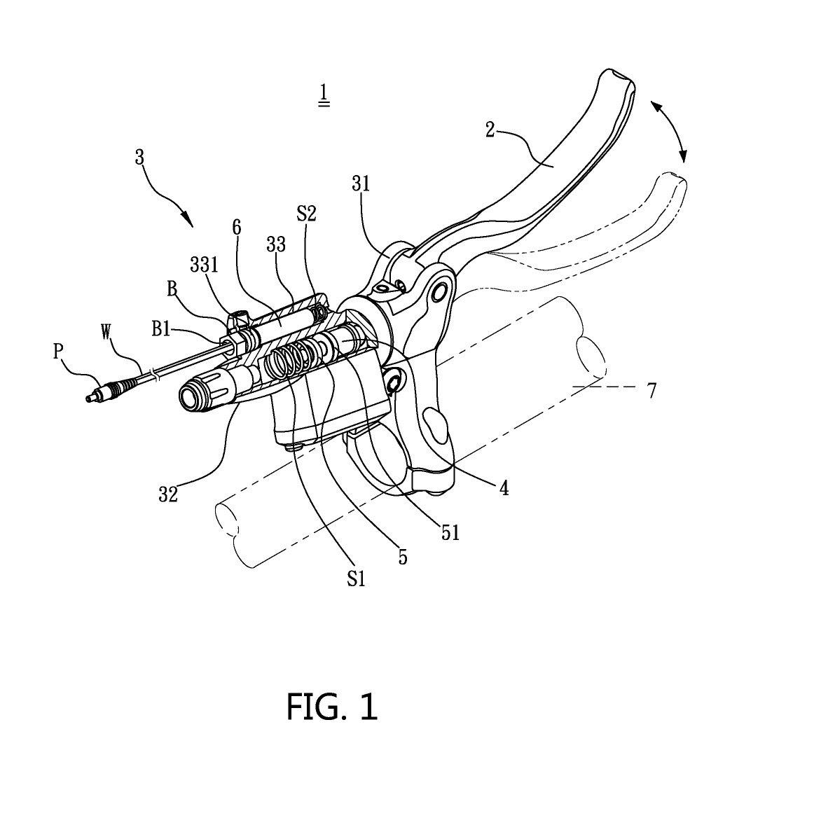

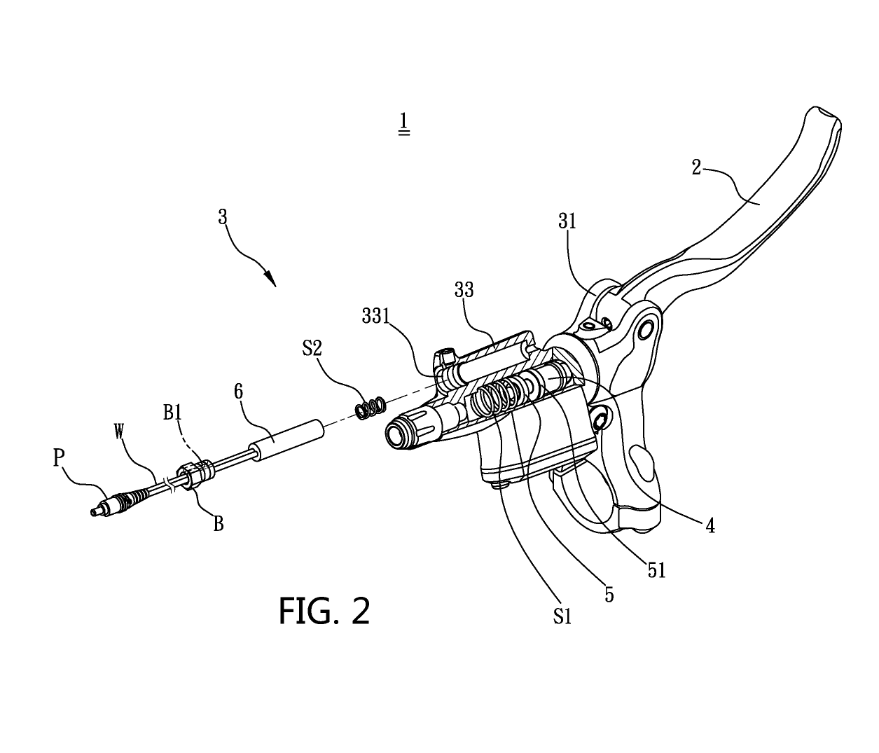

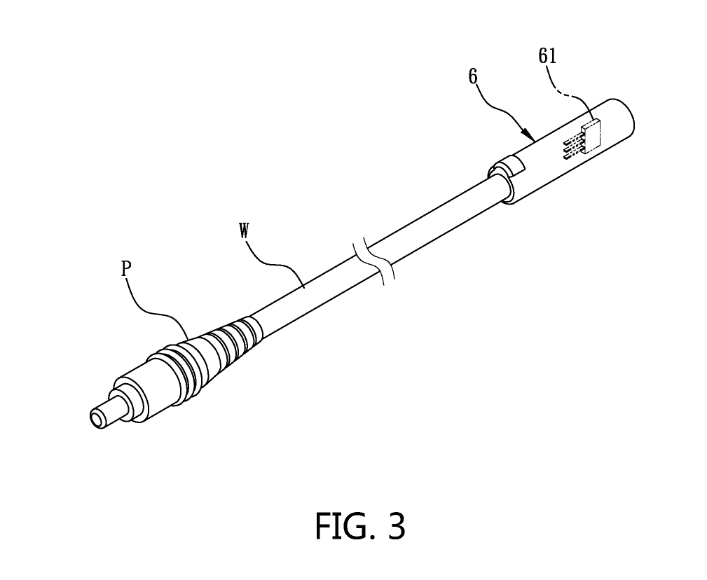

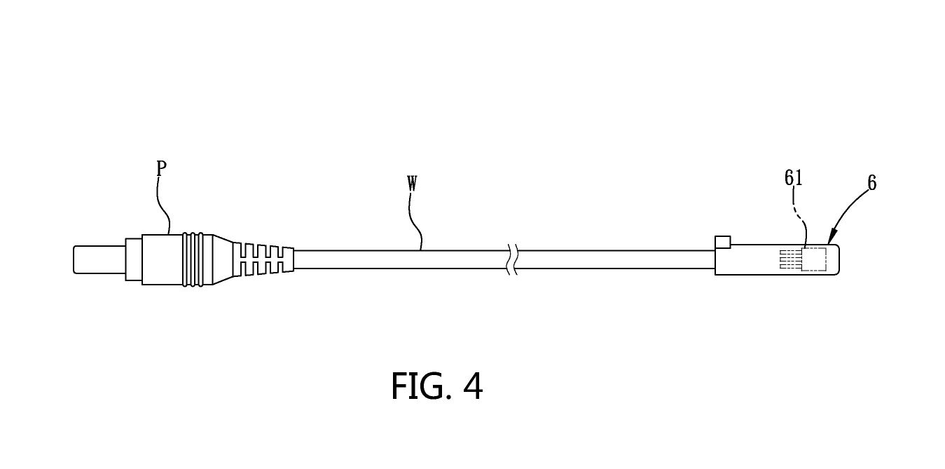

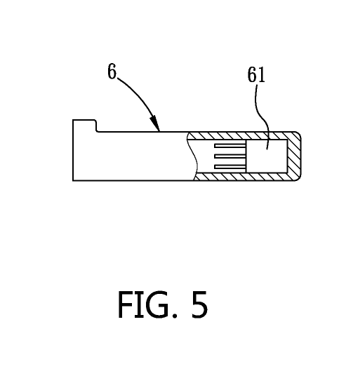

Referring to FIGS. 1 to 5, a brake operating device 1 of an electric bicycle in accordance with the invention comprises the following components as discussed in detail below.

A housing 3 comprises a pivot portion 31 pivotably secured to a brake lever 2, a hydraulic cylinder 32 communicating with the pivot portion 31, and a cylindrical socket 33 adjacent to and parallel to the hydraulic cylinder 32, the socket 33 including an opening 331 distal the brake lever 2.

The hydraulic cylinder 32 is in fluid communication with a fluid reservoir (not shown). Further, an end of the hydraulic cylinder 32 distal the brake lever 2 connected to a hydraulic brake (not shown) near the wheel (not shown) of the electric bicycle (not shown). A piston 4 has one end connected to the brake lever 2 at the pivot portion 31. Two spaced sealing rings (e.g., O-rings) 51 are put on both ends of the piston 4 respectively so as to prevent brake fluid in the cylinder 32 from flowing onto the piston 4. Otherwise, the brake fluid may leak out of the cylinder 32. A magnet (e.g., permanent magnet) 5 has one end adhered to the other end of the piston 51 (i.e., the piston 51 being a magnetic piston). A helical spring S1 has one end attached to the other end of the magnet 5 and the other end anchored in an internal shoulder of the hydraulic cylinder 32. Thus, both the piston 51 and the magnet 5 are moveably disposed in the hydraulic cylinder 32.

A Hall-effect sensor 6 is disposed in the socket 33 and comprises a Hall IC (integrated circuit) 61 proximate one end, the Hall IC 61 being a high gain IC amplifier and having a positive pin, a negative pin, and a ground pin. A helical spring S2 has one end anchored in one end of the socket 33 and the other end biasing against one end of the Hall-effect sensor 6. A screw B is adjustably threadedly secured to an internally threaded opening 331 of the socket 33 to engage the socket 33 and hold the socket 33 in place. The screw B has a central lengthwise channel B1 so a control line W may be inserted through the channel B1 to have its one end electrically connected to the Hall IC 61. The other end of the control line W is formed as an enlarged connector P connected to a DC motor (not shown) of the bicycle.

For adjusting brake sensitivity, an individual may turn the screw B to change the position of the Hall IC 61 relative to the magnet 5 so as to change a magnetic force exerted upon the Hall IC 61 by the magnet 5 (i.e., changing magnetic field). In detail, for decreasing brake sensitivity, an individual may loosen the screw B to cause the spring S2 to expand to push the Hall-effect sensor 6 toward the opening 331. Distance between the Hall IC 61 and the magnet 5 is increased. Thus, the magnetic force exerted upon the Hall IC 61 by the magnet 5 is decreased. As such, output voltage of the Hall-effect sensor 6 is decreased. And in turn, the rotation speed of the DC motor is decreased (i.e., less power or torque output). As a result, a less sensitive brake is effected when pressing the brake lever 2 against a grip 7.

To the contrary, for increasing brake sensitivity as preferred, the individual may tighten the screw B to push the Hall-effect sensor 6 to compress the spring S2. Distance between the Hall IC 61 and the magnet 5 is decreased. Thus, the magnetic force exerted upon the Hall IC 61 by the magnet 5 is increased. As such, output voltage of the Hall-effect sensor 6 is increased. And in turn, the rotation speed of the DC motor is increased (i.e., more power or torque output). As a result, a more sensitive brake is effected when pressing the brake lever 2 against the grip 7.

It is envisaged by the invention that the Hall-effect sensor 6 is highly sensitive. Further, the Hall-effect sensor 6 is more stable with both temperature and supply voltage changes.

While the invention has been described in terms of preferred embodiments, those skilled in the art will recognize that the invention can be practiced with modifications within the spirit and scope of the appended claims.

What is claimed is:

1. A brake operating device of an electric bicycle comprising:
a brake lever;
a housing comprising a pivot portion pivotably secured to the brake lever, a hydraulic cylinder, a piston disposed in the hydraulic cylinder and having one end connected to the brake lever, a spring depressible magnet disposed in the hydraulic cylinder and having one end adhered to the other end of the piston, and a cylindrical socket adjacent to and parallel to the hydraulic cylinder;
a spring depressible Hall-effect sensor disposed in the socket and comprising a Hall IC (integrated circuit);
a hollow fastener adjustably threadedly secured to an opening of the socket and engaging the Hall-effect sensor; and
a control line inserted through the fastener to electrically connect to the Hall IC.

2. The brake operating device of claim 1, wherein the Hall IC is distal the fastener.
